(19) United States
(12) Patent Application Publication
(10) Pub. No.: US 2013/0012618 A1
(43) Pub. Date: Jan. 10, 2013

(54) RESIN COMPOSITION, POLYMER, CURED FILM AND ELECTRONIC PART

(75) Inventors: Akito HIRO, Tokyo (JP); Masaaki HANAMURA, Tokyo (JP); Futoshi YAMATO, Tokyo (JP); Yuuji SHIMOYAMA, Tokyo (JP); Jun MUKAWA, Tokyo (JP); Hikaru MIZUNO, Tokyo (JP); Akari SAKO, Tokyo (JP); Tomohiko SAKURAI, Tokyo (JP)

(73) Assignee: JSR Corporation, Tokyo (JP)

(21) Appl. No.: 13/540,624

(22) Filed: Jul. 3, 2012

(30) Foreign Application Priority Data
Jul. 5, 2011 (JP) 2011-149299
Feb. 27, 2012 (JP) 2012-040286
Jun. 6, 2012 (JP) 2012-128954

(51) Int. Cl. C08L 63/10; C08F 224/00

(52) U.S. Cl. 523/400; 526/273

(57) ABSTRACT

Provided are a resin composition capable of forming a cured film excellent in elongation properties; a polymer suitable as a component contained in the composition; a cured film formed from the composition; and an electronic part including the cured film. The resin composition includes (A) a polymer containing a structural unit represented by the formula (a1) and a structural unit represented by the formula (a2); and (F) a solvent,

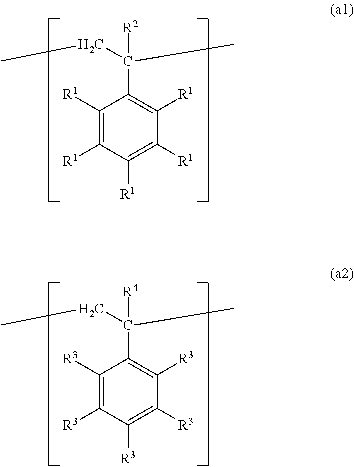

wherein in the formula (a1), R¹s are each independently a hydrogen atom or hydroxyl group, provided that at least one R¹ is hydroxyl group; and R² is a hydrogen atom or a C1-4 alkyl group; and in the formula (a2), R³s are each independently a group having a cationic polymerizable group, or a hydrogen atom, provided that at least one R³ is a group having a cationic polymerizable group; and R⁴ is a hydrogen atom or a C1-4 alkyl group.

### TECHNICAL FIELD

The present invention relates to a resin composition suitable for use in an interlaminar insulating film (passivation film), a flattening film and the like of an electronic part and the like; a polymer suitable as a component contained in such a composition; a cured film obtained by curing such a composition; and an electronic part comprising such a cured film.

### BACKGROUND ART

Conventionally, as a resin composition used to form an interlaminar insulating film employed for a semiconductor device in an electronic part, various photosensitive compositions have been proposed (for example, see Patent Literatures 1 and 2).

Patent Literature 1 discloses a positive photosensitive insulating resin composition containing a copolymer (A) having a specific structural unit, a compound (B) having a quinone diazide group, a crosslinking agent (C), a solvent (D) and an adhesion assistant (E).

Patent Literature 2 discloses a negative photosensitive insulating resin composition containing a copolymer (A) having a specific structural unit, a crosslinking agent (B), a photosensitive acid-generating agent (C), a solvent (D), an adhesion assistant (E) and crosslinked fine particles (F).

Integrated circuits (IC) for driving electronic devices such as smartphones have been recently downsized. If an insulating film in IC has low elongation properties, the insulating film becomes cracked by the impact caused when an electronic device is dropped, leading to the possibility of the failure to ensure product reliability. There is thus a demand for an organic insulating film which is high in toughness typified by elongation properties.

### CITATION LIST

Patent Literature 1: JP-A-2006-154780
Patent Literature 2: JP-A-2007-056109

### SUMMARY OF THE INVENTION

### Technical Problem

It is an object of the present invention to provide a resin composition capable of forming a cured film excellent in elongation properties. It is another object of the present invention to provide a polymer suitable as a component contained in such a composition; a cured film formed from such a composition; and an electronic part comprising such a cured film.

### Technical Solution

The present inventors earnestly made their studies to solve the above problem, and have found that the use of a resin composition and a polymer that have a constitution described below can solve the above problem, thereby completing the present invention.

That is, the present invention relates to the following [1] to [12].

[1] A resin composition comprising (A) a polymer that comprises a structural unit represented by the formula (a1) and a structural unit represented by the formula (a2); and (F) a solvent.

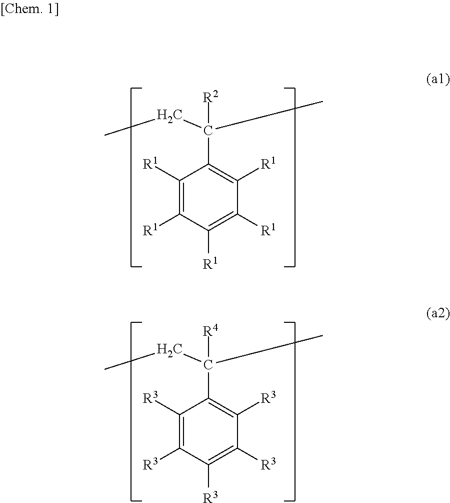

In the formula (a1), a plurality of R¹ are each independently a hydrogen atom or hydroxyl group, provided that at least one R¹ is hydroxyl group; and R² is a hydrogen atom or an alkyl group having 1 to 4 carbon atoms.

In the formula (a2), a plurality of R³ are each independently a group having a cationic polymerizable group, or a hydrogen atom, provided that at least one R³ is a group having a cationic polymerizable group; and R⁴ is a hydrogen atom or an alkyl group having 1 to 4 carbon atoms.

[2] The resin composition as described in the above [1], wherein the proportion of the content of the structural unit represented by the formula (a2) in the polymer (A) is 1 to 50 mol % based on 100 mol % of all the structural units of the polymer (A).

[3] The resin composition as described in the above [1] or [2], wherein the proportion of the total content of the structural unit represented by the formula (a1) and the structural unit represented by the formula (a2) in the polymer (A) is 50 to 100 mol % based on 100 mol % of all the structural units of the polymer (A).

[4] The resin composition as described in any one of the above [1] to [3], wherein the cationic polymerizable group in the polymer (A) is an epoxy group.

[5] The resin composition as described in any one of the above [1] to [4], which further comprises (B) a photosensitive compound.

[6] The resin composition as described in the above [5], which comprises at least a compound having a quinone diazide group or a photosensitive acid-generating agent, as the photosensitive compound (B).

[7] The resin composition as described in any one of the above [1] to [6], which further comprises (C) a crosslinking agent.

[8] The resin composition as described in the above [7], which comprises at least an oxirane ring-containing compound and an oxetane ring-containing compound that exclude the polymer (A), as the crosslinking agent (C).

[9] A polymer comprising a structural unit represented by the formula (a1) and a structural unit represented by the formula (a2).

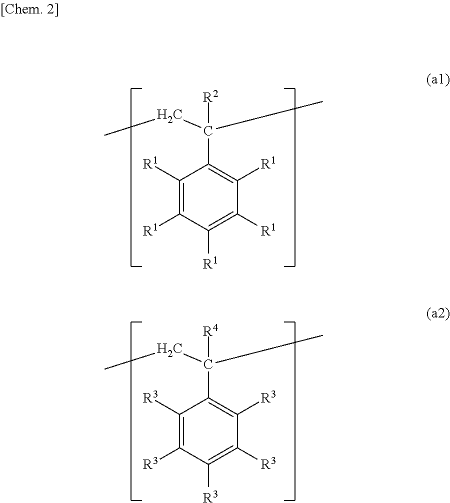

In the formula (a1), a plurality of R¹ are each independently a hydrogen atom or hydroxyl group, provided that at least one R¹ is hydroxyl group; and R² is a hydrogen atom or an alkyl group having 1 to 4 carbon atoms.

In the formula (a2), a plurality of R³ are each independently a group having a cationic polymerizable group, or a hydrogen atom, provided that at least one R³ is a group having a cationic polymerizable group; and R⁴ is a hydrogen atom or an alkyl group having 1 to 4 carbon atoms.

[10] The polymer as described in the above [9], wherein the cationic polymerizable group is an epoxy group.

[11] A cured film, which is obtained from the resin composition as described in the above [5] or [6].

[12] An electronic part comprising the cured film as described in the above [11].

### Advantageous Effects of the Invention

According to the present invention, there can be provided a resin composition capable of forming a cured film excellent in elongation properties; a polymer suitable as a component contained in such a composition; a cured film formed from such a composition; and an electronic part comprising such a cured film.

### BRIEF DESCRIPTION OF DRAWING

FIG. 1: A top view FIGURE of a base material for electrical insulating properties evaluation

### DESCRIPTION OF EMBODIMENTS

Hereinafter, the resin composition, the polymer, the cured film and the electronic part of the present invention are described.

### Resin Composition

The resin composition of the present invention comprises a specific polymer (A) and a solvent (F), and may comprise, as required, one component or two or more components selected from a photosensitive compound (B), a crosslinking agent (C), an adhesion assistant (D), crosslinked fine particles (E) and an alkali soluble resin (AR) provided that the alkali soluble resin (AR) excludes the specific polymer (A), the crosslinking agent (C) and the crosslinked fine particles (E).

Hereinafter, the polymer (A) of the present invention, which is suitable as a component contained in the above resin composition, is also described. When the resin composition of the present invention further comprises the photosensitive compound (B), such a composition is also referred to as a “photosensitive composition”.

### <Polymer (A)>

The polymer (A) of the present invention comprises a structural unit represented by the formula (a1) (hereinafter also referred to as a “structural unit (a1)”) and a structural unit represented by the formula (a2) (hereinafter also referred to as a “structural unit (a2)”).

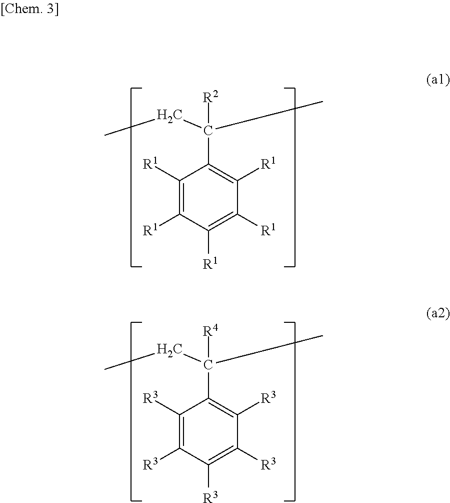

In the formula (a1),

a plurality of R¹ are each independently a hydrogen atom or hydroxyl group, provided that at least one R¹ is hydroxyl group; particularly preferably, R¹ at p-position is hydroxyl group and the other R^{1s} are hydrogen atoms; and

R² is a hydrogen atom or an alkyl group having 1 to 4 carbon atoms, preferably a hydrogen atom or methyl group.

In the formula (a2),

a plurality of R³ are each independently a group having a cationic polymerizable group, or a hydrogen atom, provided that at least one R³ is a group having a cationic polymerizable group; particularly preferably, R³ at p-position is a group having a cationic polymerizable group and the other R³s are hydrogen atoms; and

R⁴ is a hydrogen atom or an alkyl group having 1 to 4 carbon atoms, preferably a hydrogen atom or methyl group.

In the present specification, examples of the cationic polymerizable group include epoxy group, oxetanyl group, methylol group, alkoxymethylol group, dioxolane group, trioxane group, vinylether group and stylyl group. Of these, in terms of being able to form a cured film excellent in elongation properties, epoxy group and oxetanyl group are preferred; and epoxy group is particularly preferred.

In the present specification, examples of the group having a cationic polymerizable group include:

cationic polymerizable groups themselves,

groups obtained by substituting a hydrogen atom (usually one or more hydrogen atoms, preferably one hydrogen atom) of alkyl groups (preferably alkyl groups having 1 to 10 carbon atoms, more preferably alkyl groups having 1 to 5 carbon atoms) with cationic polymerizable groups; and

groups represented by the following formulae (A) to (C).

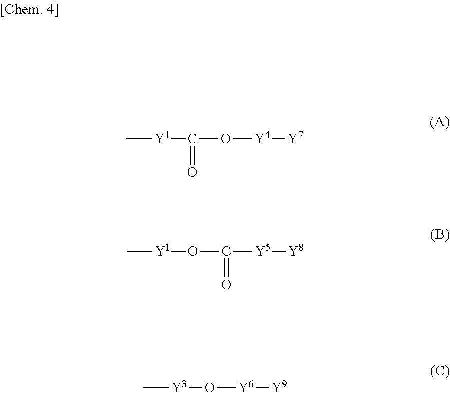

In the formulae (A) to (C):

Y¹ to Y³ are each independently a direct bond, methylene group or an alkylene group having 2 to 10 carbon atoms;

Y⁴ to Y⁶ are each independently a direct bond, methylene group or an alkylene group having 2 to 10 carbon atoms; and

Y⁷ to Y⁹ are each independently a cationic polymerizable group, preferably an epoxy group or an oxetanyl group, particularly preferably an epoxy group.

In the formula (a2), it is particularly preferred that R³ at p-position is a group represented by any of the formulae (A) to (C) and the other R³s are hydrogen atoms.

The polymer (A) may comprise, in addition to the structural unit (a1) and the structural unit (a2), a structural unit represented by the formula (a3) (hereinafter also referred to as a “structural unit (a3)”).

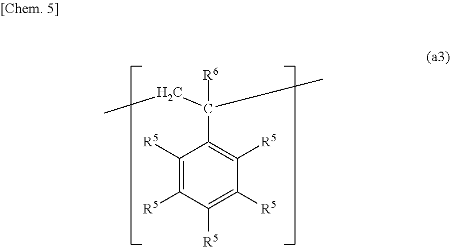

In the formula (a3):

a plurality of R⁵ are each independently a hydrogen atom, an alkyl group having 1 to 4 carbon atoms or an alkoxy group having 1 to 4 carbon atoms; and

R⁶ is a hydrogen atom or an alkyl group having 1 to 4 carbon atoms, preferably a hydrogen atom or methyl group.

The polymer (A) is alkali soluble.

The polymer (A) has a structure such that in a styrene-based skeleton, a group having a highly reactive cationic polymerizable group (crosslinkable group) has been introduced. The use of the resin composition containing the polymer (A) having the above structure allows a cured film to have improved elongation properties, presumably because (1) crosslinked sites in the cured film are uniformly dispersed and (2) the crosslinking is possible at low temperature, such as about 200° C., which leads to using less amount of a low-molecular crosslinking agent.

The use of the resin composition comprising the polymer (A) can form a cured film excellent in elongation properties and in properties such as electrical insulating properties. The use of the photosensitive composition comprising the polymer (A) and the photosensitive compound (B) can form a cured film excellent in properties such as resolution and film remaining properties.

The sequence in the polymer (A) of the structural unit (a1) and the structural unit (a2) and optionally the structural unit (a3) is not particularly limited, and the polymer (A) may be a random copolymer or a block copolymer.

In the polymer (A), the proportion of the content of the structural unit (a2) is usually 1 to 50 mol %, preferably 1 to 30 mol %, more preferably 1 to 20 mol %, based on 100 mol % of all the structural units of the polymer (A). When the proportion of the content of the structural unit (a2) is within the above range, the cationic polymerizable group (crosslinkable group) tends to make a suitable contribution to the curing of the resin composition, and a cured film tends to have improved elongation properties.

In the polymer (A), the proportion of the total content of the structural unit (a1) and the structural unit (a2) is usually 50 to 100 mol %, preferably 60 to 95 mol %, more preferably 70 to 90 mol %, based on 100 mol % of all the structural units of the polymer (A). When the proportion of the total of these components is within the above range, the polymer (A) becomes primarily composed of a styrene-based skeleton and tends to provide a cured film with improved performance in terms of e.g., heat resistance and electrical insulating properties. The content of the structural unit of the polymer (A) is measured by ²H-NMR and ¹³C-NMR analysis.

The polymer (A) usually has a weight average molecular weight (Mw), as measured by gel permeation chromatography (GPC) in terms of polystyrene, of 4,000 to 100,000, preferably 6,000 to 80,000, more preferably 8,000 to 30,000, in view of thermal shock resistance and heat resistance of a cured film and resolution of a photosensitive composition. When Mw is not less than the lower limit, a cured film tends to have improved heat resistance and elongation properties. When Mw is not more than the upper limit, the compatibility of the polymer (A) with other components and patterning properties of a photosensitive composition tend to be improved. The detail of the Mw measurement method is as described in Examples.

Hereinafter, a method for producing the polymer (A) is described.

An example of monomers capable of forming the structural unit (a1) is a monomer represented by the formula (a1′) (hereinafter also referred to as a “monomer (a1′)”). An example of monomers capable of forming the structural unit (a2) is a monomer represented by the formula (a2′) (hereinafter also referred to as a “monomer (a2′)”). An example of monomers capable of forming the structural unit (a3) is a monomer represented by the formula (a3′) (hereinafter also referred to as a “monomer (a3′)”). In the present specification, the “structural unit derived from monomers” is also referred to simply as a “monomer unit”.

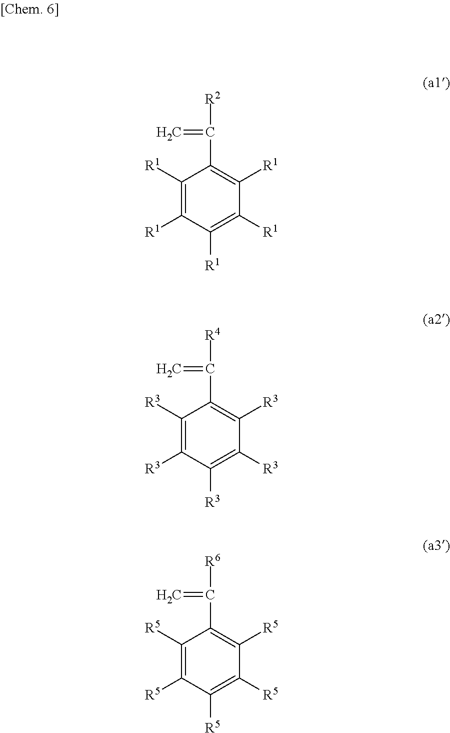

In the formula (a1′), R¹ and R² are each defined in the same manner as described for R¹ and R² of the formula (a1).

In the formula (a2′), R³ and R⁴ are each defined in the same manner as described for R³ and R⁴ of the formula (a2).

In the formula (a3′), R⁵ and R⁶ are each defined in the same manner as described for R⁵ and R⁶ of the formula (a3).

Examples of the monomer (a1′) include aromatic vinyl compounds having a phenolic hydroxyl group such as p-hydroxystyrene, m-hydroxystyrene, o-hydroxystyrene, p-isopropenylphenol, m-isopropenylphenol and o-isopropenylphenol. Of these, p-hydroxystyrene and p-isopropenylphenol are preferred.

The monomer (a1′) may have its hydroxyl group protected by e.g., t-butyl group or acetyl group. The structural unit derived from the monomer having its hydroxyl group protected is converted to the structural unit having a phenolic hydroxyl group, by deprotecting a polymer obtained by a known method (for example, by performing a reaction in a solvent under an acid catalyst such as hydrochloric acid, sulfuric acid at a temperature of 50 to 150° C. for 1 to 30 hours).

The monomers (a1′) may be used singly, or two or more kinds may be used in combination.

Examples of the monomer (a2′) include p-vinylbenzyl glycidyl ether and p-vinylbenzyl oxetanyl ether. The monomers (a2′) may be used singly, or two or more kinds may be used in combination.

Examples of the monomer (a3′) include aromatic vinyl compounds such as styrene, α-methylstyrene, o-methylstyrene, m-methylstyrene, p-methylstyrene, o-methoxystyrene, m-methoxystyrene and p-methoxystyrene. The monomers (a3′) may be used singly, or two or more kinds may be used in combination.

The polymer (A) is a copolymer of the monomer (a1′) and the monomer (a2′), and optionally the monomer (a3′), and may consist only of the structural unit (a1) and the structural unit (a2), and optionally the structural unit (a3). The polymer (A) may comprise structural units derived from other monomers than these monomers.

Examples of other monomers include unsaturated carboxylic acids or acid anhydrides thereof, esters of the unsaturated carboxylic acids, unsaturated nitriles, unsaturated amides, unsaturated imides, unsaturated alcohols, compounds having an alicyclic skeleton and nitrogen-containing vinyl compounds.

More specific examples thereof include:

unsaturated carboxylic acids or acid anhydrides thereof such as (meth)acrylic acid, maleic acid, fumaric acid, crotonic acid, mesaconic acid, citraconic acid, itaconic acid, maleic anhydride and citraconic anhydride;

esters such as methyl ester, ethyl ester, n-propyl ester, i-propyl ester, n-butyl ester, i-butyl ester, sec-butyl ester, t-butyl ester, n-amyl ester, n-hexyl ester, cyclohexyl ester, 2-hydroxyethyl ester, 2-hydroxypropyl ester, 3-hydroxypropyl ester, 2,2-dimethyl-3-hydroxypropyl ester, benzyl ester, isobornyl ester, tricyclodecanyl ester, 1-adamantyl ester, of the unsaturated carboxylic acids;

unsaturated nitriles such as (meth)acrylonitrile, maleonitrile, fumaronitrile, mesacononitrile, citracononitrile and itacononitrile; unsaturated amides such as (meth)acrylamide, crotonamide, maleamide, fumaramide, mesaconamide, citraconamide and itaconamide; unsaturated imides such as maleimide, N-phenylmaleimide and N-cyclohexylmaleimide; unsaturated alcohols such as (meth)allyl alcohol;

compounds having an alicyclic skeleton such as bicyclo[2.2.1]hepto-2-ene(norbornene), tetracyclo[4.4.0.1^{2,5}.1^{7,10}]dodeca-3-ene, cyclobutene, cyclopentene, cyclooctene, and dicyclopentadiene, tricyclo[5.2.1.0^{2,6}]decene; and

nitrogen-containing vinyl compounds such as N-vinylaniline, vinylpyridines, N-vinyl-ε-caprolactam, N-vinylpyrrolidone, N-vinylimidazole and N-vinylcarbazole.

The polymer (A) can be obtained, for example, by polymerizing the monomer (a1′) and/or a compound in which the hydroxyl group of the monomer (a1′) is protected, and the monomer (a2′), and optionally the monomer (a3′) and other monomers, in the presence of an initiator in a solvent. The polymerization method is not particularly limited. In order to obtain a polymer having the molecular weight described above, a preferred method is radical polymerization, anionic polymerization or the like.

The polymers (A) may be used singly or two or more kinds may be used in combination.

The content of the polymer (A) is usually 30 to 90% by mass, preferably 40 to 90% by mass, more preferably 50 to 90% by mass of all the components excluding a solvent (F) of the resin composition of the present invention. When the content of the polymer (A) is within the above range, a resin composition capable of forming a cured film excellent in elongation properties and a photosensitive composition excellent in resolution are obtained.

### <Alkali Soluble Resin (AR)>

The resin composition of the present invention may further comprise an alkali soluble resin (AR), provided that the alkali soluble resin (AR) excludes the specific polymer (A), the crosslinking agent (C) and the crosslinked fine particles (E), in order to improve resolution of the photosensitive composition, reduce internal stress of a cured film obtained from the resin composition, improve the resistance of the cured film in a developing solution, and improve electrical insulating properties of the cured film.

The alkali soluble resin (AR) is a resin which is dissolved in an amount of 0.001 mg/mL or more in an aqueous tetramethylammonium hydroxide solution (23° C.) having a concentration of 2.38% by mass. Specific examples thereof include resins having at least one functional group selected from carboxylic acid group, phenolic hydroxyl group and sulfonic acid group.

Examples of the alkali soluble resin (AR) include novolak resins; alkali soluble resins having a phenolic hydroxyl group excluding the novolak resins; polyamide acids, which are polyimide precursors, and the partially-imidized products thereof; and polyhydroxyamides, which are polybenzoxazole precursors.

The novolak resins are obtainable, for example, by condensing phenols and aldehydes in the presence of an acid catalyst. Examples of the phenols include phenol, o-cresol, m-cresol, p-cresol, o-ethylphenol, m-ethylphenol, p-ethylphenol, o-butylphenol, m-butylphenol, p-butylphenol, 2,3-xylenol, 2,4-xylenol, 2,5-xylenol, 2,6-xylenol, 3,4-xylenol, 3,5-xylenol, 2,3,5-trimethylphenol, 3,4,5-trimethylphenol, catechol, resorcinol, pyrogallol, α-naphthol and β-naphthol. Examples of the aldehydes include formaldehyde, paraformaldehyde, acetaldehyde, benzaldehyde and salicylaldehyde.

Specific examples of the novolak resins include phenol/formaldehyde condensed novolak resin, cresol/formaldehyde condensed novolak resin, cresol/salicylaldehyde condensed novolak resin, phenol-naphthol/formaldehyde condensed novolak resin, and resins obtained by modifying novolak resins with rubber-like polymers having a polymerizable vinyl group, such as butadiene-based polymers (e.g., resins described in JP-A-2010-015101).

Examples of the alkali soluble resin having a phenolic hydroxyl group include homopolymers or copolymers of monomers having a phenolic hydroxyl group such as p-hydroxystyrene, m-hydroxystyrene, o-hydroxystyrene, p-isopropenylphenol, m-isopropenylphenol and o-isopropenylphenol; phenol-xylylene glycol condensed resin; cresol-xylylene glycol condensed resin; and phenol-dicyclopentadiene condensed resin.

Examples of the homopolymers of monomers having a phenolic hydroxyl group include homopolymers composed of the structural unit (a1). Examples of the copolymers of monomers having a phenolic hydroxyl group include copolymers having the structural unit (a1) and the structural unit (a3), provided that the copolymers exclude the specific polymer (A).

The alkali soluble resins having a phenolic hydroxyl group may be a AB-type block copolymer or a ABA-type block polymer, as described in JP-A-2001-247656, JP-A-2003-342327, JP-A-2004-240144 and the like.

Examples of the block polymer include block polymers composed of a polymer block of the structural unit (a1) and a polymer block of a structural unit derived from at least one monomer selected from (meth)acrylic acid ester, 1,3-butadiene and isoprene; and block polymers composed of a polymer block of the structural unit (a1) and a polymer block of a structural unit derived from CH₂═CH(OR), wherein R is an alkyl group, an aryl group, an arylalkyl group or an alkoxyalkyl group, and one or more hydrogen atoms in these groups may be substituted by a fluorine atom.

The alkali soluble resin (AR) usually has a weight average molecular weight (Mw), as measured by gel permeation chromatography (GPC) in terms of polystyrene, of 1,000 to 100,000. The detail of the Mw measurement method is as described in Examples.

In the resin composition of the present invention, the content of the alkali soluble resin (AR) is preferably 0 to 200 parts by mass, more preferably 10 to 150 parts by mass, still more preferably 20 to 130 parts by mass, based on 100 parts by mass of the polymer (A).

### <Photosensitive Compound (B)>

The resin composition of the present invention may further comprise a photosensitive compound (B) in order to have photosensitivity. In this case, the photosensitive resin composition may be a positive photosensitive composition or may be a negative photosensitive composition. The photosensitive compound (B) is appropriately selectable depending on the positive photosensitive composition or the negative photosensitive composition.

As the photosensitive compound (B), a compound having a quinone diazide group (hereinafter also referred to as a “quinone diazide compound (B1)”) and the like can be mentioned for the positive photosensitive composition; and a photosensitive acid-generating agent (hereinafter also referred to as an “acid-generating agent (B2)”) and the like can be mentioned for the negative photosensitive composition.

### <<Quinone Diazide Compound (B1)>>

The quinone diazide compound (B1) is an ester compound formed between a compound having one or more phenolic hydroxyl groups and 1,2-naphthoquinone diazide-4-sulfonic acid or 1,2-naphthoquinone diazide-5-sulfonic acid.

The photosensitive composition comprising the quinone diazide compound (B1) gives a coating film that is hardly dissolved in an alkaline developing solution. The quinone diazide compound (B1) is a compound in which the quinone diazide group is decomposed by light irradiation to generate carboxyl group, and thus this coating film, when irradiated with light, changes its state from being at an alkali hardly-soluble state to being at an alkali easily-soluble state; by utilizing this property, a positive pattern is formed.

Examples of the compound having one or more phenolic hydroxyl groups include compounds represented by the following formulae (B1-1) to (B1-5). These compounds may be used singly or two or more kinds may be used in combination.

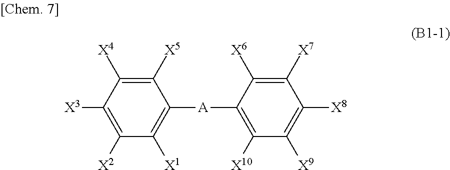

In the formula (B1-1):

X¹ to X¹⁰ are each independently a hydrogen atom, an alkyl group having 1 to 4 carbon atoms, an alkoxy group having 1 to 4 carbon atoms or hydroxyl group;

at least one of X¹ to X⁵ is hydroxyl group; and

A is a direct bond, —O—, —S—, —CH₂—, —C(CH₃)₂—, —C(CF₃)₂—, carbonyl group (—C(═O)—) or sulfonyl group (—S(═O)₂—).

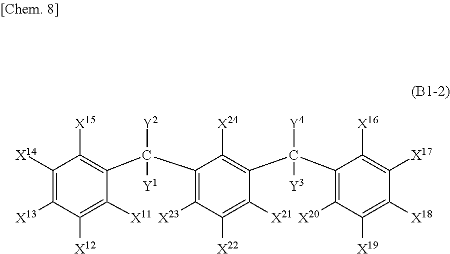

In the formula (B1-2):

X¹¹ to X²⁴ are each independently a hydrogen atom, an alkyl group having 1 to 4 carbon atoms, an alkoxy group having 1 to 4 carbon atoms or hydroxyl group;

at least one of X¹¹ to X¹⁵ is hydroxyl group; and

Y¹ to Y⁴ are each independently a hydrogen atom or an alkyl group having 1 to 4 carbon atoms.

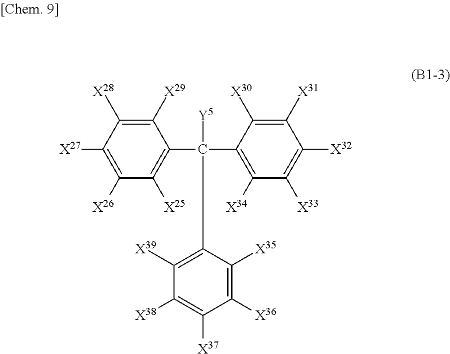

In the formula (B1-3):

X²⁵ to X³⁹ are each independently a hydrogen atom, an alkyl group having 1 to 4 carbon atoms, an alkoxy group having 1 to 4 carbon atoms or hydroxyl group;

at least one of X²⁵ to X²⁹ is hydroxyl group;

at least one of X³⁰ to X³⁴ is hydroxyl group; and

Y⁵ is a hydrogen atom or an alkyl group having 1 to 4 carbon atoms.

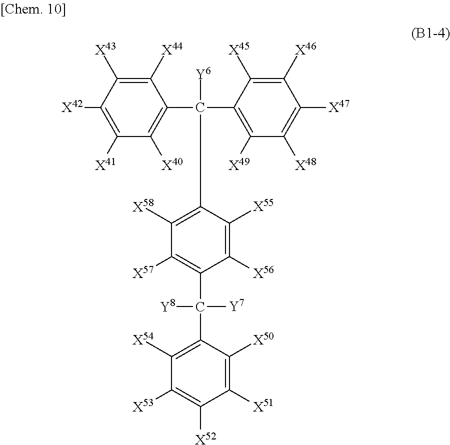

In the formula (31-4):

X⁴⁰ to X⁵⁸ are each independently a hydrogen atom, an alkyl group having 1 to 4 carbon atoms, an alkoxy group having 1 to 4 carbon atoms or hydroxyl group;

at least one of X⁴⁰ to X⁴⁴ is hydroxyl group;

at least one of X⁴⁵ to X⁴⁹ is hydroxyl group;

at least one of X⁵⁰ to X⁵⁴ is hydroxyl group; and

Y⁶ to Y⁸ are each independently a hydrogen atom or an alkyl group having 1 to 4 carbon atoms.

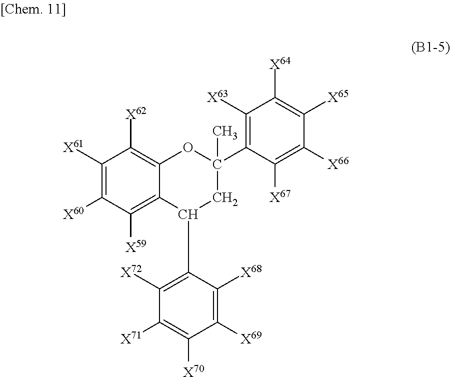

In the formula (B1-5):

X⁵⁹ to X⁷² are each independently a hydrogen atom, an alkyl group having 1 to 4 carbon atoms, an alkoxy group having 1 to 4 carbon atoms or hydroxyl group;

at least one of X⁵⁹ to X⁶² is hydroxyl group; and

at least one of X⁶³ to X⁶⁷ is hydroxyl group.

Examples of the quinone diazide compound (B) include

ester compounds formed between
4,4′-dihydroxydiphenylmethane,
4,4′-dihydroxydiphenyl ether,
2,3,4-trihydroxybenzophenone,
2,3,4,4′-tetrahydroxybenzophenone,
2,3,4,2′,4′-pentahydroxybenzophenone,
tris(4-hydroxyphenyl)methane,
tris(4-hydroxyphenyl)ethane,
1,1-bis(4-hydroxyphenyl)-1-phenylethane,
1,3-bis[1-(4-hydroxyphenyl)-1-methylethyl]benzene,
1,4-bis[1-(4-hydroxyphenyl)-1-methylethyl]benzene,
4,6-bis[1-(4-hydroxyphenyl)-1-methylethyl]-1,3-dihydroxybenzene,
1,1-bis(4-hydroxyphenyl)-1-[4-{1-(4-hydroxyphenyl)-1-methylethyl}phenyl]ethane or the like, and
1,2-naphthoquinone diazide-4-sulfonic acid or
1,2-naphthoquinone diazide-5-sulfonic acid.

The quinone diazide compounds (B1) may be used singly or two or more kinds may be used in combination.

In the photosensitive composition, in the case where the quinone diazide compound (B1) is used as the photosensitive compound (B), the content of the quinone diazide compound (B1) is usually 5 to 50 parts by mass, preferably 10 to 30 parts by mass, more preferably 15 to 30 parts by mass, based on 100 parts by mass of the polymer (A) (based on 100 parts by mass of the total of the polymer (A) and the alkali soluble resin (AR) when the alkali soluble resin (AR) is also contained). When the content of the quinone diazide compound (B1) is not less than the above lower limit, the film remaining percentage of an unexposed part is improved and a film is easily patterned with fidelity to a mask pattern. When the content of the quinone diazide compound (B1) is not more than the above upper limit, a cured film excellent in pattern shape is easily obtained and foaming during curing can be prevented.

### <<Acid-Generating Agent (B2)>>

The acid-generating agent (B2) is a compound to form an acid by light irradiation. This acid acts on the cationic polymerizable group of the polymer (A) and the like and thereby a crosslinked structure is formed. By the formation of the crosslinked structure, the coating film obtained from the photosensitive composition comprising the acid-generating agent (B2) changes its state from being at an alkali easily-soluble state to being at an alkali hardly-soluble state; by utilizing this property, a negative pattern is formed.

Examples of the acid-generating agent (B2) include onium salt compounds, halogen-containing compounds, sulfone compounds, sulfonic acid compounds, sulfonimide compounds and diazomethane compounds. Of these, in terms of being able to form a cured film excellent in elongation properties, onium salt compounds are preferred.

Examples of the onium salt compounds include iodonium salts, sulfonium salts, phosphonium salts, diazonium salts and pyridinium salts. As a preferable onium salt, specific examples include diphenyliodonium trifluoromethanesulfonate, diphenyliodonium p-toluenesulfonate, diphenyliodonium hexafluoroantimonate, diphenyliodonium hexafluorophosphate, diphenyliodonium tetrafluoroborate, triphenylsulfonium trifluoromethanesulfonate, triphenylsulfonium p-toluenesulfonate, triphenylsulfonium hexafluoroantimonate, 4-t-butylphenyl.diphenylsulfonium trifluoromethanesulfonate, 4-t-butylphenyl.diphenylsulfonium p-toluenesulfonate, 4,7-di-n-butoxynaphthyltetrahydrothiophenium trifluoromethanesulfonate, 4-(phenylthio)phenyldiphenylsulfoniumtris(pentafluoroethyl)trifluorophosphate, and 4-(phenylthio)phenyldiphenylsulfoniumhexafluorophosphate.

Examples of the halogen-containing compounds include haloalkyl group-containing hydrocarbon compounds and haloalkyl group-containing heterocyclic compounds. As a preferable halogen-containing compound, specific examples include 1,10-dibromo-n-decane, 1,1-bis(4-chlorophenyl)-2,2,2-trichloroethane and s-triazine derivatives such as phenyl-bis(trichloromethyl)-s-triazine, 4-methoxyphenyl-bis(trichloromethyl)-s-triazine, styryl-bis(trichloromethyl)-s-triazine and naphthyl-bis(trichloromethyl)-s-triazine.

Examples of the sulfone compounds include β-ketosulfone compounds, β-sulfonylsulfone compounds and α-diazo compounds of these compounds. As a preferable sulfone compound, specific examples include 4-trisphenacylsulfone, mesitylphenacylsulfone and bis(phenacylsulfonyl)methane.

Examples of the sulfonic acid compounds include alkylsulfonic acid esters, haloalkylsulfonic acid esters, arylsulfonic acid esters and iminosulfonates. As a preferable sulfonic acid compound, specific examples include benzointosylate, pyrogallol tristrifluoromethanesulfonate, o-nitrobenzyl trifluoromethanesulfonate and o-nitrobenzyl p-toluenesulfonate.

Examples of the sulfonimide compounds include N-(trifluoromethylsulfonyloxy)succinimide, N-(trifluoromethylsulfonyloxy)phthalimide, N-(trifluoromethylsulfonyloxy)diphenylmaleimide, N-(trifluoromethylsulfonyloxy)bicyclo[2.2.1]hepto-5-ene-2,3-d icarboxylmide and N-(trifluoromethylsulfonyloxy)naphthylimide.

Examples of the diazomethane compounds include bis(trifluoromethylsulfonyl)diazomethane, bis(cyclohexylsulfonyl)diazomethane and bis(phenylsulfonyl)diazomethane.

The acid-generating agents (B2) may be used singly or two or more kinds may be used in combination.

In the photosensitive composition, in the case where the acid-generating agent (B2) is used as the photosensitive compound (B), the content of the acid-generating agent (B2) is usually 0.1 to 10 parts by mass, preferably 0.3 to 5 parts by mass, more preferably 0.5 to 5 parts by mass, based on 100 parts by mass of the polymer (A) (based on 100 parts by mass of the total of the polymer (A) and the alkali soluble resin (AR) when the alkali soluble resin (AR) is also contained). When the content of the acid-generating agent (B2) is not less than the above lower limit, curing at an exposed part is sufficient and heat resistance is easily improved. If the content of the acid-generating agent (B2) is more than the above upper limit, the transparency with respect to exposure light may be lowered and resolution may be decreased.

### <Crosslinking Agent (C)>

The resin composition of the present invention may further comprise a crosslinking agent (C) in order to improve its curing properties. The crosslinking agent (C) serves as a crosslinking component (curing component) reactive with the polymer (A).

Examples of the crosslinking agent (C) include compounds having two or more alkyl-etherified amino groups (hereinafter also referred to as an “amino group-containing compound”), oxirane ring-containing compounds, oxetane ring-containing compounds, isocyanate group-containing compounds (including blocked compounds), aldehyde group-containing phenol compounds and methylol group-containing phenol compounds. From the crosslinking agent (C), compounds corresponding to the polymer (A) are excluded. From the oxirane ring-containing compounds, silane coupling agents having an epoxy group are excluded. From the isocyanate group-containing compounds, silane coupling agents having an isocyanate group are excluded.

An example of the alkyl-etherified amino group is a group represented by:

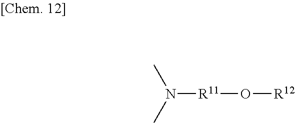

wherein R¹¹ is methylene group or an alkylene group, and R¹² is an alkyl group.

Examples of the amino group-containing compounds include compounds obtainable by alkyl-etherifying all of or part of (at least two) active methylol groups (CH₂OH group) in a nitrogen compound, such as (poly)methylolated melamine, (poly)methylolated glycoluril, (poly)methylolated benzoguanamine and (poly)methylolated urea. The alkyl groups for alkyl-etherification include methyl group, ethyl group and butyl group and may be the same as or different from one another. The methylol groups without alkyl-etherification may be self-condensed in one molecule, or may be condensed between two molecules to form an oligomer component. Specific employable examples include hexamethoxymethylmelamine, hexabutoxymethylmelamine, tetramethoxymethylglycoluril and tetrabutoxymethylglycoluril.

The oxirane ring-containing compounds are not particularly limited as long as containing an oxirane ring (also called an oxyranyl group or an epoxy group) in the molecule. Example thereof include phenol novolak epoxy resin, cresol novolak epoxy resin, bisphenol epoxy resin, trisphenol epoxy resin, tetraphenol epoxy resin, phenol-xylylene epoxy resin, naphthol-xylylene epoxy resin, phenol-naphthol epoxy resin, phenol-dicyclopentadiene epoxy resin, alicyclic epoxy resin and aliphatic epoxy resin.

Specific examples of the oxirane ring-containing compounds include resorcinol diglycidyl ether, pentaerythritol glycidyl ether, trimethylolpropane polyglycidyl ether, glycerol polyglycidyl ether, phenyl glycidyl ether, neopentyl glycol diglycidyl ether, ethylene/polyethylene glycol diglycidyl ether, propylene/polypropylene glycol diglycidyl ether, 1,6-hexanediol diglycidyl ether, sorbitol polyglycidyl ether, propylene glycol diglycidyl ether and trimethylolpropane triglycidyl ether.

The oxetane ring-containing compounds are not particularly limited as long as containing an oxetane ring (also called an oxetanyl group) in the molecule. Examples thereof include compounds represented by the general formulae (c-1) to (c-3).

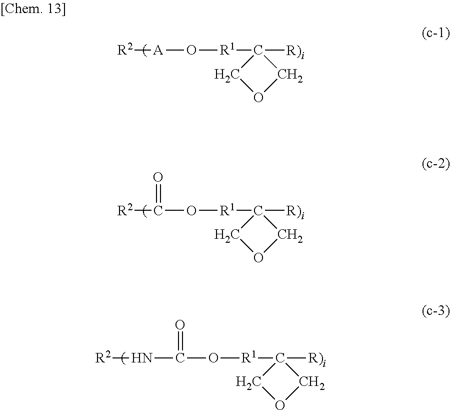

In the formulae (c-1) to (c-3):

A is a direct bond, or an alkylene group such as methylene group, ethylene group, propylene group;

R is an alkyl group such as methyl group, ethyl group, propyl group;

R¹ is an alkylene group such as methylene group, ethylene group, propylene group;

R² is an alkyl group such as methyl group, ethyl group, propyl group and hexyl group, an aryl group such as phenyl group and xylyl group, a group represented by the following formula:

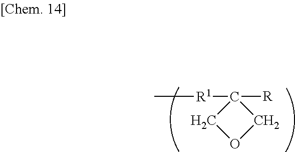

(wherein R and R¹ are each defined in the same manner as described for R and R¹ in the formulae (c-1) to (c-3)), a dimethylsiloxane residue represented by the following formula (i), an alkylene group such as methylene group, ethylene group and propylene group, phenylene group, or a group represented by any of the following formulae (II) to (vi); and

“i” is equal to the valence of R² and is an integer of from 1 to 4.

In the following formulae (i) to (vi), the mark “*” indicates a bonding site.

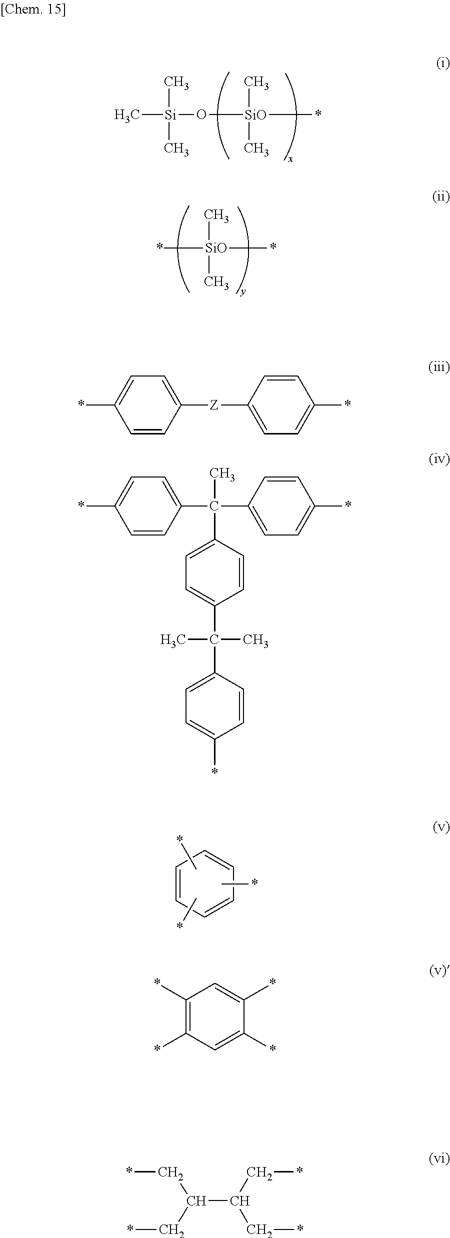

In the formulae (i) and (ii), “x” and “y” are each independently an integer of from 0 to 50. In the formula (iii),

Z is a direct bond, or a divalent group represented by —O—, —CH₂—, —C(CH₃)₂—, —C(CF₃)₂—, —CO— or —SO₂—.

Specific examples of the compounds represented by the general formulae (c-1) to (c-3) include 1,4-bis{[(3-ethyloxetane-3-yl)methoxy]methyl}benzene (product name: “OXT-121”, manufactured by TOAGOSEI CO., LTD.), 3-ethyl-3-{[(3-ethyloxetane-3-yl)methoxy]methyl}oxetane (product name: “OXT-221”, manufactured by TOAGOSEI CO., LTD.), 4,4′-bis[(3-ethyl-3-oxetanyl)methoxymethyl]biphenyl (product name: “ETERNACOLL OXBP”, manufactured by UBE INDUSTRIES, LTD.), bis[(3-ethyl-3-oxetanylmethoxy)methyl-phenyl]ether, bis[(3-ethyl-3-oxetanylmethoxy)methyl-phenyl]propane, bis[(3-ethyl-3-oxetanylmethoxy)methyl-phenyl]sulfone, bis[(3-ethyl-3-oxetanylmethoxy)methyl-phenyl]ketone, bis[(3-ethyl-3-oxetanylmethoxy)methyl-phenyl]hexafluoropropane, tri[(3-ethyl-3-oxetanylmethoxy)methyl]benzene, tetra[(3-ethyl-3-oxetanylmethoxy)methyl]benzene, and compounds represented by the following formulae (c-a) to (c-d).

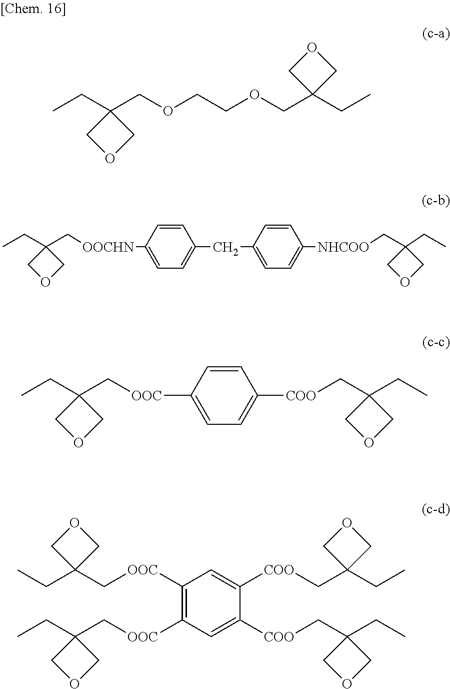

In addition to these compounds, there can be mentioned high molecular weight compounds having a polyvalent oxetane ring, with examples thereof including oxetane oligomers (product name: “Oligo-OXT”, manufactured by TOAGOSEI CO., LTD.), and compounds represented by the following formulae (c-e) to (c-g).

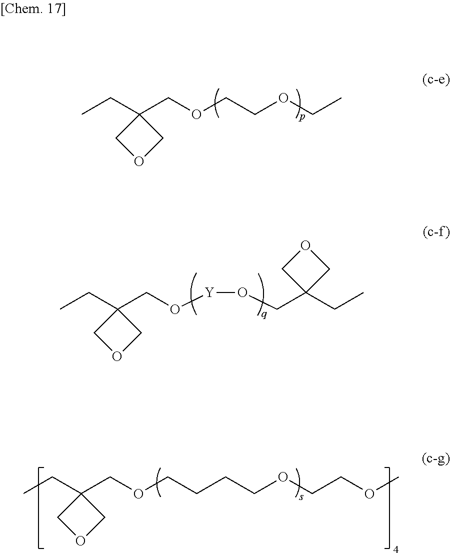

In the formulae (c-e) to (c-g), “p”, “q” and “s” are each independently an integer of from 0 to 10000, preferably an integer of from 1 to 10. In the formula (c-f), Y is an alkylene group such as ethylene group and propylene group, or a group represented by —CH₂-Ph-CH₂—, wherein Ph is a phenylene group.

Among the crosslinking agents (C), because of further improving elongation properties of a cured film, it is preferred to use both an oxirane ring-containing compound and an oxetane ring-containing compound. For example, an oxetane ring-containing compound is used preferably in an amount of 30 to 300 parts by mass, more preferably 50 to 200 parts by mass, based on 100 parts by mass of an oxirane ring-containing compound.

The crosslinking agents (C) may be used singly, or two or more kinds may be used in combination.

In the resin composition of the present invention, the content of the crosslinking agent (C) is usually 1 to 60 parts by mass, preferably 5 to 50 parts by mass, more preferably 5 to 40 parts by mass, based on 100 parts by mass of the polymer (A) (based on 100 parts by mass of the total of the polymer (A) and the alkali soluble resin (AR) when the alkali soluble resin (AR) is also contained). When the content of the crosslinking agent (C) is within the above range, curing reaction sufficiently progresses, and a cured film formed by using the photosensitive composition has good pattern shape as well as has excellent elongation properties and excellent heat resistance and electrical insulating properties.

### <Adhesion Assistant (D)>

The resin composition of the present invention, in order to have improved adhesion to a substrate, may further comprise an adhesion assistant (D). A preferred example of the adhesion assistant is a functional silane coupling agent, for example a silane coupling agent having a reactive substituent such as carboxyl group, methacryloyl group, vinyl group, isocyanate group and epoxy group. Specific examples thereof include trimethoxysilylbenzoic acid, γ-methacryloxypropyltrimethoxysilane, vinyltriacetoxysilane, vinyltrimethoxysilane, γ-isocyanato propyltriethoxysilane, γ-glycidoxypropyltrimethoxysilane, β-(3,4-epoxycyclohexyl)ethyltrimethoxysilane and 1,3,5-N-tris(trimethoxysilylpropyl)isocyanurate.

In the resin composition of the present invention, the content of the adhesion assistant (D) is preferably 0.5 to 10 parts by mass, more preferably 0.5 to 5 parts by mass, based on 100 parts by mass of the polymer (A) (based on 100 parts by mass of the total of the polymer (A) and the alkali soluble resin (AR) when the alkali soluble resin (AR) is also contained). When the content of the adhesion assistant (D) is within the above range, the adhesion to a substrate of a cured product obtained by curing the resin composition of the present invention is further improved.

### <Crosslinked Fine Particles (E)>

The resin composition of the present invention, in order to allow a cured film to have improved insulating properties and thermal shock resistance, may further comprise crosslinked fine particles (E). Examples of the crosslinked fine particles (E) include crosslinked fine particles of a copolymer of a monomer having hydroxyl group and/or carboxyl group (hereinafter also referred to as a “functional group-containing monomer”) with a crosslinkable monomer having two or more polymerizable unsaturated groups (hereinafter referred to as a “crosslinkable monomer”). Further, crosslinked fine particles of a copolymer obtained by further copolymerizing an additional monomer may be used.

Examples of the functional group-containing monomer include hydroxyl group-containing unsaturated compounds such as hydroxyethyl(meth)acrylate, hydroxypropyl(meth)acrylate and hydroxybutyl(meth)acrylate; and unsaturated acid compounds such as (meth)acrylic acid, itaconic acid, succinic acid-β-(meth)acryloxyethyl, maleic acid-β-(meth)acryloxyethyl, phthalic acid-β-(meth)acryloxyethyl and hexahydrophthalic acid-β-(meth)acryloxyethyl. The functional group-containing monomers may be used singly or two or more kinds may be used in combination.

The proportion of the content of structural units derived from the functional group-containing monomers is usually 5 to 90 mol %, preferably 5 to 70 mol %, more preferably 5 to 50 mol % in terms of a value calculated from an acid value or a hydroxyl value as measured in accordance with JIS K 0070, provided that the amount of all the structural units derived from monomers in the crosslinked fine particles (E) is 100 mol %.

Examples of the crosslinkable monomer include compounds having plural polymerizable unsaturated groups such as divinylbenzene, diallylphthalate, ethylene glycol di(meth)acrylate, propylene glycol di(meth)acrylate, trimethylolpropane tri(meth)acrylate, pentaerythritol tri(meth)acrylate, polyethylene glycol di(meth)acrylate and polypropylene glycol di(meth)acrylate. Divinylbenzene is preferable. The crosslinkable monomers may be used singly or two or more kinds may be used in combination.

The proportion of the content of structural units derived from the crosslinkable monomers is preferably 0.5 to 20 mol %, more preferably 0.5 to 10 mol %, provided that the amount of all the structural units derived from monomers in the crosslinked fine particles (E) is 100 mol %. When the proportion of the content is within the above range, the fine particles can have stabilized shape.

Examples of the additional monomer include:

diene compounds such as butadiene, isoprene, dimethyl butadiene, chloroprene and 1,3-pentadiene;

unsaturated nitrile compounds such as (meth)acrylonitrile, α-chloroacrylonitrile, α-chloromethylacrylonitrile, α-methoxyacrylonitrile, α-ethoxyacrylonitrile, nitrile crotonate, nitrile cinnamate, dinitrile itaconate, dinitrile maleate and dinitrile fumarate;

unsaturated amides such as (meth)acrylamide, dimethyl(meth)acrylamide, N,N′-methylenebis(meth)acrylamide, N,N′-ethylenebis(meth)acrylamide, N,N′-hexamethylenebis(meth)acrylamide, N-hydroxymethyl(meth)acrylamide, N-(2-hydroxyethyl)(meth)acrylamide, N,N-bis(2-hydroxyethyl)(meth)acrylamide, crotonic acid amide and cinnamic acid amide;

(meth)acrylic acid esters such as methyl(meth)acrylate, ethyl(meth)acrylate, propyl(meth)acrylate, butyl

(meth)acrylate, hexyl(meth)acrylate, lauryl(meth)acrylate, polyethylene glycol(meth)acrylate and polypropylene glycol(meth)acrylate;

aromatic vinyl compounds such as styrene, α-methyl styrene, o-methoxystyrene, p-hydroxystyrene and p-isopropenyl phenol;

epoxy(meth)acrylates obtained by reaction of bisphenol A diglycidyl ether, a glycol diglycidyl ether or the like with (meth)acrylic acid, a hydroxyalkyl(meth)acrylate or the like;

urethane(meth)acrylates obtained by reaction of a hydroxyalkyl(meth)acrylate with a polyisocyanate;

epoxy group-containing unsaturated compounds such as glycidyl(meth)acrylate and (meth)allyl glycidyl ether; and

amino group-containing unsaturated compounds such as dimethyl amino(meth)acrylate and diethyl amino(meth)acrylate.

Of these additional monomers, diene compounds, styrene and acrylonitriles are preferable; and in particular, butadiene and styrene are more preferable. These additional monomers may be used singly or two or more kinds may be used in combination.

The proportion of the content of structural units derived from the additional monomers is preferably 9.5 to 94.5 mol %, more preferably 29.5 to 94.5 mol %, provided that the amount of all the structural units derived from monomers in the crosslinked fine particles (E) is 100 mol %.

The crosslinked fine particles (E) may be used singly or two or more kinds may be used in combination.

The glass transition temperature (Tg) of the copolymer constituting the crosslinked fine particles (E) is preferably 20° C. or lower, more preferably 10° C. or lower, still more preferably 0° C. or lower. If Tg of the crosslinked fine particles (E) is higher than the above value, the cured film may have cracking or reduced elongation properties. The lower limit of Tg of the crosslinked fine particles (E) is usually −70° C.

The crosslinked fine particles (E) are fine particles of copolymers. The average primary particle diameter of the crosslinked fine particles (E) is usually 30 to 500 nm, preferably 40 to 200 nm, more preferably 50 to 120 nm. As a method to control the average primary particle diameter of the crosslinked fine particles (E), for example, in the case where the crosslinked fine particles are prepared by emulsion polymerization, adjusting the amount of an emulsifying agent to be used thereby controlling the number of micelles during emulsion polymerization can control the average primary particle diameter.

The average primary particle diameter of the crosslinked fine particles (E) is a value determined by diluting a dispersion of the crosslinked fine particles (E) through an ordinary method and measuring the diameters using a particle size distribution measuring apparatus by light scattering LPA-3000 manufactured by Otsuka Electronics Co. Ltd.

In the resin composition of the present invention, the content of the crosslinked fine particles (E) is preferably 0 to 200 parts by mass, more preferably 0.1 to 150 parts by mass, still more preferably 0.5 to 100 parts by mass, based on 100 parts by mass of the polymer (A) (based on 100 parts by mass of the total of the polymer (A) and the alkali soluble resin (AR) when the alkali soluble resin (AR) is also contained).

### <Solvent (F)>

The resin composition of the present invention comprises a solvent (F). The use of the solvent (F) can improve the handling properties of the resin composition and control viscosity and storage stability of the resin composition.

Examples of the solvent (F) include:

ethylene glycol monoalkyl ether acetates such as ethylene glycol monomethyl ether acetate and ethylene glycol monoethyl ether acetate;

propylene glycol monoalkyl ethers such as propylene glycol monomethyl ether, propylene glycol monoethyl ether, propylene glycol monopropyl ether and propylene glycol monobutyl ether;

propylene glycol dialkyl ethers such as propylene glycol dimethyl ether, propylene glycol diethyl ether, propylene glycol dipropyl ether and propylene glycol dibutyl ether;

propylene glycol monoalkyl ether acetates such as propylene glycol monomethyl ether acetate, propylene glycol monoethyl ether acetate, propylene glycol monopropyl ether acetate and propylene glycol monobutyl ether acetate;

cellosolves such as ethyl cellosolve and butyl cellosolve;

carbitols such as butyl carbitol;

lactic acid esters such as methyl lactate, ethyl lactate, n-propyl lactate and isopropyl lactate;

aliphatic carboxylic acid esters such as ethyl acetate, n-propyl acetate, isopropyl acetate, n-butyl acetate, isobutyl acetate, n-amyl acetate, isoamyl acetate, isopropyl propionate, n-butyl propionate and isobutyl propionate;

other esters such as methyl 3-methoxypropionate, ethyl 3-methoxypropionate, methyl 3-ethoxypropionate, ethyl 3-ethoxypropionate, methyl pyruvate and ethyl pyruvate;

aromatic hydrocarbons such as toluene and xylene;

ketones such as 2-heptanone, 3-heptanone, 4-heptanone and cyclohexanone;

amides such as N-dimethylformamide, N-methylacetamide, N,N-dimethylacetamide and N-methylpyrrolidone; and

lactones such as γ-butyrolactone.

Of these, propylene glycol monomethyl ether acetate, ethyl lactate and propylene glycol monomethyl ether are preferable.

The solvents (F) may be used singly or two or more kinds may be used in combination.

In the resin composition of the present invention, the content of the solvent (F) is usually 40 to 900 parts by mass, preferably 60 to 400 parts by mass based on 100 parts by mass of the total of components excluding the solvent (F) in the composition.

### <Other Additives>

The resin composition of the present invention may further comprise various additives such as leveling agents, surfactants, sensitizers, inorganic fillers and quenchers in a range which is not detrimental to the object and properties of the present invention.

### <Preparation Method of Resin Composition>

The resin composition of the present invention can be prepared by homogenously mixing the individual components. A mixture obtained after homogenously mixing the individual components may be subjected to filtration using a filter in order to remove contaminants.

### Cured Film

The cured film of the present invention is obtained by curing the above photosensitive composition. The use of the above photosensitive composition can produce a cured film that is excellent in elongation properties and becomes hardly cracked even when subjected to impact. Thus, the cured film of the present invention can be used suitably for surface-protecting films, flattening films, interlaminar insulating films, insulating film materials for high-density mounting substrates, photosensitive adhesives, pressure sensitive adhesives and the like of electronic parts such as circuit substrates (semiconductor devices), semiconductor packages and display devices, particularly integrated circuits (IC) for driving electronic devices such as smartphones.

The cured film of the present invention can be produced, for example, by a process described below.

Specifically, the process for producing the cured film comprises:

a step of applying the photosensitive composition on a support to form a coating film (coating step);

a step of subjecting the above coating film via a desired mask pattern to exposure (exposure step); and

a step of developing the above coating film with an alkaline developing solution to dissolve and remove an exposed part (in the case of the positive photosensitive composition) or an unexposed part (in the case of the negative photosensitive composition) thereby forming the desired pattern on the support (development step), these steps being carried out in this order.

### [1] Coating Step

In coating step, the photosensitive composition is applied on a support so that a finally-obtainable cured film (pattern) would have a thickness of e.g., 0.1 to 100 μm, and is dried with an oven or a hot plate, e.g., at a temperature of 50 to 140° C. for 10 to 360 seconds to thereby remove a solvent. Thereby, the coating film is formed on the support.

Examples of the support include a silicon wafer, a compound semiconductor wafer, a metal thin film-having wafer, a glass substrate, a quartz substrate, a ceramic substrate, an aluminum substrate and a substrate having a semiconductor chip on a surface of any of these supports. Examples of the coating method include dipping, spraying, bar coating, roll coating, spin coating, curtain coating, gravure printing, silk screen method and ink jet method.

### [2] Exposure Step

In exposure step, the coating film is subjected via a desired mask pattern to exposure, for example, using a contact aligner, a stepper or a scanner. Examples of the exposure light include ultraviolet light and visible light. Usually, a light with a wavelength of 200 to 500 nm (e.g., i-ray (365 nm)) is used. The activated light irradiation quantity varies depending on type and blending amount of the individual components in the photosensitive composition, the thickness of the coating film and the like, but the exposure quantity is usually 100 to 1500 mJ/cm² when i-ray is used as the exposure light.

The exposure may be followed by heat treatment (hereinafter also referred to as “PEB treatment”). PEB conditions, varying depending on contents of the individual components in the photosensitive composition, the film thickness and the like, are such that the treatment temperature is usually 70 to 150° C., preferably 80 to 120° C., and the treatment time is about 1 to 60 minutes.

### [3] Development Step

In development step, the above coating film is developed with an alkaline developing solution to dissolve and remove an exposed part (in the case of the positive photosensitive composition) or an unexposed part (in the case of the negative photosensitive composition), to thereby form the desired pattern on the support.

Examples of the development method include shower development, spray development, immersion development and puddle development. The development conditions are, for example, such that the development temperature is about 20 to 40° C. and the development time is about 1 to 10 minutes.

Examples of the alkaline developing solution include an alkaline aqueous solution obtained by dissolving, in water, an alkaline compound such as sodium hydroxide, potassium hydroxide, ammonia water, tetramethylammonium hydroxide and choline in order for the solution to have a concentration of 1 to 10% by mass. Into the above alkaline aqueous solution, for example, a water-soluble organic solvent such as methanol and ethanol, a surfactant and the like may be added in an appropriate amount. After development using an alkaline developing solution, the coating film may be washed with water and dried.

### [4] Thermal Treatment Step

After development step, in order to fully exhibit properties as an insulating film, the above pattern may be subjected to heat treatment for sufficient curing as needed. Curing conditions are not particularly limited. According to uses of the cured film, the film is heated, for example, at a temperature of 100 to 250° C. for about 30 minutes to 10 hours. In order for curing to sufficiently proceed or in order to prevent the deformation of the pattern shape, heating may be carried out through two stages. For example, at a first stage, the film is heated at a temperature of 50 to 100° C. for about 10 minutes to 2 hours, and at a second stage, the film is further heated at a temperature in the range of higher than 100° C. to not higher than 250° C. for about 20 minutes to 8 hours. Provided that the curing conditions are as described above, the heating equipment may be a typical oven, infrared furnace or the like.

### Electronic Part

The use of the resin composition of the present invention can produce an electronic part comprising the above cured film: for example, an electronic part such as a circuit substrate (semiconductor device), a semiconductor package or a display device which has at least one cured film selected from a surface-protecting film, a flattening film and an interlaminar insulating film.

### EXAMPLES

Hereinafter, the present invention is described in greater detail with reference to Examples, but the present invention is in no way limited by these Examples. In Examples and Comparative Examples set forth hereinafter, “part (s)” is used to mean “part (s) by mass” unless otherwise noted.

### Measurement Method of Weight Average Molecular Weight (Mw) of Polymer (A) and Other Polymer

Under conditions described below, Mw was measured by gel permeation chromatography.

Column: TSK-M and TSK2500, each of which is a column manufactured by Tosoh Corporation, were connected in series.

### Solvent: N,N-dimethylformamide

### Temperature: 40° C.

Detection method: refractive index method
Standard substance: polystyrene

### Measurement Method of Content of Structural Unit of Polymer (A)

The content of the structural unit of the polymer (A) was measured by ²H-NMR and ¹³C-NMR analysis.

### 1. Synthesis of Polymer

### Example 1

### Synthesis of Polymer (A1)

In a flask, 85 parts of p-hydroxystyrene, 18 parts of p-vinylbenzyl glycidyl ether, 21 parts of styrene and 4 parts of azobisisobutyronitrile were dissolved in 150 parts of propylene glycol dimethyl ether, to prepare a mixture liquid. This mixture liquid was heated at 70° C. for 10 hours. The mixture liquid after heating was poured into a solution composed of toluene and hexane, and a deposit precipitated was washed with hexane, to provide a copolymer of p-hydroxystyrene/p-vinylbenzyl glycidyl ether/styrene (hereinafter also referred to as a “polymer (A1)”).

The polymer (A1) had a weight average molecular weight (Mw) of 8,800. The polymer (A1) was a polymer containing 70 mol % of a p-hydroxystyrene unit, 10 mol % of a p-vinylbenzyl glycidyl ether unit and 20 mol % of a styrene unit.

p-vinylbenzyl glycidyl ether is represented by the following formula.

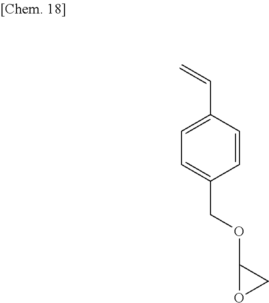

### Example 2

### Synthesis of Polymer (A2)

In the same procedure as in Example 1, a copolymer of p-hydroxystyrene/p-vinylbenzyl glycidyl ether/styrene (hereinafter also referred to as a “polymer (A2)”) was obtained which had a weight average molecular weight (Mw) of 10,000 and contained 60 mol % of a p-hydroxystyrene unit, 30 mol % of a p-vinylbenzyl glycidyl ether unit and 10 mol % of a styrene unit.

### Synthesis Example 1

### Synthesis of Polymer (AR2)

Into a pressure-resistant container, a methylene chloride solution of 4-hydroxystyrene was introduced under the flowing of nitrogen. Then, this solution was cooled to −78° C. While stirring this solution, as a cationic polymerization catalyst, HI—ZnI₂ was added in such a manner that the amount thereof would be 1/500 mol relative to 1 mol of 4-hydroxystyrene, to thereby cationically polymerize 4-hydroxystyrene. After the conversion degree of 4-hydroxystyrene was confirmed by TSC method to reach 98% or more, into this reaction system, ethylvinyl ether was added under the flowing of nitrogen, whereby block copolymerization was performed for 8 hours by living cationic polymerization. The temperature of the resultant polymer solution was slowly elevated to room temperature. By adding, to the polymer solution, methanol in an amount (in terms of volume) five times the amount of this polymer solution, the block copolymer generated was solidified and collected. This block copolymer was purified by reprecipitation through an ordinary method. Then, the purified block copolymer was dried under reduced pressure at 50° C. for one day, to provide a polymer (AR2).

The polymer (AR2), when analyzed by ¹³C-NMR, was found to be a ABA-type block copolymer in which blocks of structural units derived from 4-hydroxystyrene was bonded to both ends of a block of a structural unit derived from ethylvinyl ether.

The polymer (AR2) had a weight average molecular weight (Mw) of 30,000. The polymer (AR2) was a polymer containing 40 mol % of a structural unit derived from ethylvinyl ether and 60 mol % of a structural unit derived from 4-hydroxystyrene.

### Synthesis Example 2

### Synthesis of Polymer (AR3)

In 1000 mL of tetrahydrofuran, 0.06 g of dilithiobutane was dissolved, and the solution was cooled to −70° C. To this solution, 60 g of 1,3-butadiene was added, and polymerization was performed for 3 hours. Then, 40 g of p-t-butoxystyrene was added, and polymerization was further performed for 2 hours. By adding methanol, polymerization was terminated. The resultant solution was mixed with an excess of methanol, and a polymer generated was solidified. The polymer obtained was dissolved in 500 g of tetrahydrofuran. Then, 5 g of p-toluenesulfonic acid monohydrate and 10 g of distilled water were added, and heat refluxing was performed for 12 hours. Thereafter, the polymerized solution was subjected to reprecipitation and filtration using distilled water, to provide a polymer (AR3).

The polymer (AR3), when analyzed by ¹³C-NMR, was found to be a ABA-type block copolymer in which blocks of structural units derived from 4-hydroxystyrene was bonded to both ends of a block of a structural unit derived from 1,3-butadiene.

The polymer (AR3) had a weight average molecular weight (Mw) of 20,000. The polymer (AR3) was a polymer containing 30 mol % of a structural unit derived from 1,3-butadiene and 70 mol % of a structural unit derived from 4-hydroxystyrene.

### 2. Preparation of Photosensitive Composition

### Example 3

100 parts of a polymer (A1), 3 parts of a photosensitive compound (B1), 20 parts of a crosslinking agent (C1), 20 parts of a crosslinking agent (C2) and 3 parts of an adhesion assistant (D1) were dissolved in 180 parts of a solvent (F1), to thereby prepare a photosensitive composition. The photosensitive composition obtained was used for its prescribed evaluations.

### Examples 4 to 24 and Comparative Examples 1 to 3

The same operation was performed as in Example 3, except that in Example 3, the type and the amount of the blending components were changed as shown in Table 1-1 and Table 1-2, to thereby prepare a photosensitive composition. The photosensitive compositions obtained were used for their prescribed evaluations.

The detail of each component in Table 1-1 and Table 1-2 is described as follows.

A1: polymer (A1) obtained in Example 1
A2: polymer (A2) obtained in Example 2
AR-1: copolymer of p-hydroxystyrene/styrene=80/20
(molar ratio) (Mw=10,000, Mw/Mn=3.5)
AR-2: polymer (AR2) obtained in Synthesis Example 1
AR-3: polymer (AR3) obtained in Synthesis Example 2
B1: 4-(phenylthio)phenyldiphenylsulfonium tris(pentafluoroethyl)trifluorophosphate (manufactured by SAN-APRO LTD., product name: “CPI-210S”)
B2: condensation product of 1,1-bis(4-hydroxyphenyl)-1-[4-[1-(4-hydroxyphenyl)-1-methylethyl]phenyl]ethane and 1,2-naphthoquinone diazide-5-sulfonic acid
(molar ratio=1.0:2.0)
B3: condensation product of 1,1-bis(4-hydroxyphenyl)-1-phenyl ethane and 1,2-naphthoquinone diazide-5-sulfonic acid
(molar ratio=1.0:1.5)
B4: 4-(phenylthio)phenyldiphenylsulfoniumhexafluorophosphate (manufactured by SAN-APRO LTD., product name: “CPI-110P”)
C1: 1,4-bis{[(3-ethyloxetane-3-yl)methoxy]methyl}benzene (manufactured by TOAGOSEI CO., LTD., product name: “OXT-121”)
C2: pentaerythritol glycidyl ether (manufactured by Nagase Chemtex Corporation, product name: “Denacol EX411”)
C3: product name: “EP-828”

(manufactured by Japan Epoxy Resins Co., Ltd., bisphenol A type epoxy resin)

C4: product name: “CYMEL300” (manufactured by Mitsui Cytec, Ltd.)
C5: product name: “CYMEL1174” (manufacturedbyMitsuiCytec, Ltd.)
C6: product name: “Adekaresin EP-4010S” (manufactured by ADEKA)
D1: γ-glycidoxypropyltrimethoxysilane (manufactured by Chisso Corporation, product name: “S-510”)
E1: crosslinked fine particles of copolymer of butadiene, styrene, hydroxybutyl methacrylate, methacrylic acid and divinylbenzene (butadiene/styrene/hydroxybutyl methacrylate/methacrylic acid/divinylbenzene=60/20/12/6/2 (% by mass), average primary particle diameter: 65 nm)
F1: ethyl lactate

### 3. Evaluation

With regard to the photosensitive compositions of Examples and Comparative Examples, evaluations described below were made. The results are shown in Table 1-1 and Table 1-2.

### 3-1. Elongation

The photosensitive composition was applied on a substrate with a releasing agent, and then heated with an oven at 110° C. for 5 minutes, to prepare a resin coating film having a uniform thickness of 20 μm. Then, using Aligner (“MA-100” manufactured by Suss Microtec), the entire surface of the resin coating film was irradiated with ultraviolet light from a high-pressure mercury lamp in such a manner that the exposure quantity at a wavelength of 365 nm would be 1000 mJ/cm². Then, the resin coating film was heated with a hot plate under a nitrogen atmosphere at 110° C. for 5 minutes, and further heated under a nitrogen atmosphere at 200° C. for 1 hour.

From the substrate with a releasing agent, the resin coating film after heating was released and cut into a strip shape of 2.5 cm×0.5 cm. The tensile elongation at break (%) of the resin coating film was measured with a tensile/compression tester (SDWS-0201, manufactured by IMADA SEISAKUSHO CO., LTD.) (conditions: distance between chucks: 2.5 cm, tensile rate: 5 mm/min, measurement temperature: 23° C.). Values measured five times were averaged, and the average value is indicated.

### 3-2. Internal Stress of Insulating Film

The photosensitive composition was applied by spin coating on a silicon wafer of 8 inches, and then heated with a hot plate at 110° C. for 3 minutes, to prepare a resin coating film having a uniform thickness of 20 μm. Then, using Aligner (“MA-100” manufactured by Suss Microtec), the resin coating film was irradiated with ultraviolet light from a high-pressure mercury lamp in such a manner that the exposure quantity at a wavelength of 365 nm would be 500 mJ/cm². Then, the resin coating film was heated (PEB) with a hot plate at 110° C. for 3 minutes, and developed by being immersed in an aqueous tetramethylammonium hydroxide solution having a concentration of 2.38% by mass at 23° C. for 120 seconds. Then, the resin coating film was cured by heating with a convection type oven at 190° C. for 1 hour, to form an insulating film. With regard to the stress of the silicon wafer, the difference between before and after the formation of the insulating film was measured with a stress measurement apparatus (FLX-2320-s manufactured by TOHO Technology Corporation (technology formerly owned by KLA-Tencor)).

### 3-3. Resolution

The photosensitive composition was applied by spin coating on a silicon wafer of 6 inches, and then heated with a hot plate at 110° C. for 5 minutes, to prepare a resin coating film having a uniform thickness of 20 μm. Then, using Aligner (“MA-150” manufactured by Suss Microtec), the resin coating film was irradiated with ultraviolet light from a high-pressure mercury lamp via a mask pattern in such a manner that the exposure quantity at a wavelength of 350 nm would be 8000 J/m². Then, the resin coating film was developed by being immersed in an aqueous tetramethylammonium hydroxide solution having a concentration of 2.38% by mass at 23° C. for 180 seconds. Then, the developed resin coating film was washed with ultrapure water for 60 seconds, and dried by air. Thereafter, the film was observed with a microscope (MHL110 manufactured by OLYMPUS Corporation). The dimension of the resolved minimum pattern was defined as the resolution.

### 3-4. Film Remaining Percentage

The photosensitive composition was applied by spin coating on a silicon wafer of 6 inches, and then heated with a hot plate at 110° C. for 3 minutes, to prepare a resin coating film having a uniform thickness of 20 μm. Then, using Aligner (“MA-150” manufactured by Suss Microtec), the resin coating film was irradiated with ultraviolet light from a high-pressure mercury lamp via a mask pattern in such a manner that the exposure quantity at a wavelength of 420 nm would be 500 mJ/cm². Then, the resin coating film was heated (PEB) with a hot plate at 110° C. for 3 minutes, and developed by being immersed in an aqueous tetramethylammonium hydroxide solution having a concentration of 2.38% by mass at 23° C. for 120 seconds. From the film thickness before development and a film thickness after development, the film remaining percentage was calculated.

### 3-5. Electrical Insulating Properties

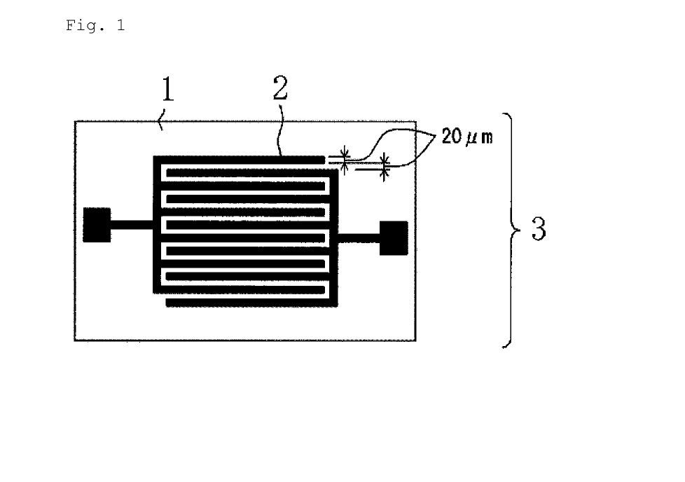

The photosensitive composition was applied on a base material 3 having a substrate 1 and a patterned copper foil 2 formed on the substrate 1 that was prepared for evaluation of electrical insulating properties as shown in FIG. 1. Then, the composition was heated with a hot plate at 110° C. for 5 minutes, to prepare a base material having a resin coating film with a thickness of 10 μm formed on the copper foil 2. Then, the resin coating film was cured by heating at 200° C. for 1 hour with a convection type oven, to prepare a cured film. The test base material obtained was set in a migration evaluation system (AEI, EHS-221MD manufactured by ESPEC Corp.), and was treated at a temperature of 121° C., a humidity of 85%, a pressure of 1.2 atm, an applied voltage of 5 V for 200 hours. Then, the resistance value (Ω) of the test base material was measured to check electrical insulating properties.

TABLE 1-1

| | | | Ex. 3 | Ex. 4 | Ex. 5 | Ex. 6 | Ex. 7 | Ex. 8 |
|---|---|---|---|---|---|---|---|---|
| Blending | Polymer (A) | A1 | 100 | | 100 | 100 | | 50 |
| components in | | A2 | | 100 | | | 50 | |
| photosensitive | Other polymer | AR-1 | | | | | 50 | |
| composition | | AR-2 | | | | | | 50 |
| (unit: part | | AR-3 | | | | | | |
| by mass) | Photosensitive | B1 | 3 | 3 | 3 | 3 | 3 | 3 |
| | compound (B) | B2 | | | | | | |
| | | B3 | | | | | | |
| | | B4 | | | | | | |
| | Crosslinking | C1 | 20 | 20 | 20 | 10 | 20 | 20 |
| | agent (C) | C2 | 20 | 20 | 20 | 20 | 20 | 20 |
| | | C3 | | | | 10 | 10 | 10 |
| | | C4 | | | | | | |
| | | C5 | | | | | | |
| | | C6 | | | | | | |
| | Adhesion | D1 | 3 | 3 | 3 | 2 | 3 | 3 |
| | assistant (D) | | | | | | | |
| | Crosslinked fine | E1 | | | 5 | | | |
| | particles (E) | | | | | | | |
| | Solvent (F) | F1 | 180 | 180 | 180 | 180 | 180 | 180 |
| Properties of | Elongation (%) | | 13 | 13 | 13 | 11 | 9 | 8 |
| photosensitive | Internal stress (MPa) | | 9 | 14 | 9 | 10 | 13 | 9 |
| composition | Resolution (μm) | | 10 | 10 | 15 | 10 | 10 | 10 |
| | Film remaining percentage (%) | | >90 | >90 | >90 | >90 | >90 | >90 |
| | Electrical insulating properties (Ω) | | >10¹⁰ | >10¹⁰ | >10¹⁰ | >10¹⁰ | >10¹⁰ | >10¹⁰ |
| | | | | | | | Comp. | Comp. |
| | | | Ex. 9 | Ex. 10 | Ex. 11 | Ex. 12 | Ex. 1 | Ex. 2 |
| Blending | Polymer (A) | A1 | 100 | 50 | 100 | | | |
| components in | | A2 | | | | 100 | | |
| photosensitive | Other polymer | AR-1 | | | | | 100 | |
| composition | | AR-2 | | 50 | | | | 100 |
| (unit: part | | AR-3 | | | | | | |
| by mass) | Photosensitive | B1 | 3 | 3 | | | 3 | 3 |
| | compound (B) | B2 | | | | | | |
| | | B3 | | | | | | |
| | | B4 | | | 3 | 3 | | |
| | Crosslinking | C1 | 10 | 20 | 20 | 20 | 20 | 20 |
| | agent (C) | C2 | 20 | 20 | 20 | 20 | 20 | 20 |
| | | C3 | | | | | | |
| | | C4 | | | | | | |
| | | C5 | | | | | | |
| | | C6 | 10 | 10 | | | | |
| | Adhesion | D1 | 3 | 3 | 3 | 3 | 3 | 2 |
| | assistant (D) | | | | | | | |
| | Crosslinked fine | E1 | | | | | | |
| | particles (E) | | | | | | | |
| | Solvent (F) | F1 | 180 | 180 | 180 | 180 | 180 | 180 |

| | | | | | | | |
|---|---|---|---|---|---|---|---|
| Properties of | Elongation (%) | 20 | 19 | 12 | 11 | 3 | 3 |
| photosensitive | Internal stress (MPa) | 12 | 10 | 10 | 13 | 12 | 10 |
| composition | Resolution (μm) | 10 | 10 | 10 | 10 | 10 | 10 |
| | Film remaining percentage (%) | >90 | >90 | >90 | >90 | >90 | >90 |
| | Electrical insulating properties (Ω) | >10¹⁰ | >10¹⁰ | >10¹⁰ | >10¹⁰ | >10¹⁰ | >10¹⁰ |

TABLE 1-2

| | | | Ex. 13 | Ex. 14 | Ex. 15 | Ex. 16 | Ex. 17 | Ex. 18 | Ex. 19 |
|---|---|---|---|---|---|---|---|---|---|
| Blending | Polymer (A) | A1 | 100 | | 100 | | 50 | 70 | 70 |
| components in | | A2 | | 100 | | 100 | 50 | | |
| photosensitive | Other polymer | AR-1 | | | | | | 30 | |
| composition | | AR-2 | | | | | | | 30 |
| (unit: part | | AR-3 | | | | | | | |
| by mass) | Photosensitive | B1 | | | | | | | |
| | compound (B) | B2 | 20 | 20 | 20 | | | 20 | 20 |
| | | B3 | | | | 20 | 20 | | |
| | | B4 | | | | | | | |
| | Crosslinking | C1 | | | | | | | |
| | agent (C) | C2 | | | | | | | |
| | | C3 | | | | | | | |
| | | C4 | 20 | 20 | | 20 | 20 | | 20 |
| | | C5 | | | 20 | | | 20 | |
| | | C6 | | | | | | | |
| | Adhesion | D1 | 3 | 2 | 2 | 3 | 2 | 2 | 2 |
| | assistant (D) | | | | | | | | |
| | Crosslinked fine | E1 | | | | | | | |
| | particles (E) | | | | | | | | |
| | Solvent (F) | F1 | 140 | 140 | 140 | 140 | 140 | 140 | 140 |

| | | | | | | | | |
|---|---|---|---|---|---|---|---|---|
| Properties of | Elongation (%) | 10 | 10 | 9 | 9 | 10 | 7 | 7 |
| photosensitive | Internal stress (MPa) | — | — | — | — | — | — | — |
| composition | Resolution (μm) | 10 | 10 | 10 | 10 | 10 | 10 | 10 |
| | Film remaining percentage (%) | >90 | >90 | >90 | >90 | >90 | >90 | >90 |
| | Electrical insulating properties (Ω) | >10¹⁰ | >10¹⁰ | >10¹⁰ | >10¹⁰ | >10¹⁰ | >10¹⁰ | >10¹⁰ |

| | | | | | | | | Comp. |
|---|---|---|---|---|---|---|---|---|
| | | | Ex. 20 | Ex. 21 | Ex. 22 | Ex. 23 | Ex. 24 | Ex. 3 |
| Blending | Polymer (A) | A1 | 70 | 100 | 100 | 70 | 70 | |
| components in | | A2 | | | | | | |
| photosensitive | Other polymer | AR-1 | | | | 30 | | 100 |
| composition | | AR-2 | | | | | 30 | |
| (unit: part | | AR-3 | 30 | | | | | |
| by mass) | Photosensitive | B1 | | | | | | |
| | compound (B) | B2 | 20 | 20 | 20 | 20 | 20 | 20 |
| | | B3 | | | | | | |
| | | B4 | | | | | | |
| | Crosslinking | C1 | | | | | | |
| | agent (C) | C2 | | | | | | |
| | | C3 | | 10 | | 10 | 10 | |
| | | C4 | 20 | 20 | 20 | 20 | 20 | 20 |
| | | C5 | | | | | | |
| | | C6 | | | 10 | | | |
| | Adhesion | D1 | 2 | 3 | 3 | 2 | 2 | 2 |
| | assistant (D) | | | | | | | |
| | Crosslinked fine | E1 | | | | | | |
| | particles (E) | | | | | | | |
| | Solvent (F) | F1 | 140 | 140 | 140 | 140 | 140 | 140 |

| | | | | | | | |
|---|---|---|---|---|---|---|---|
| Properties of | Elongation (%) | 7 | 10 | 11 | 8 | 9 | 5 |
| photosensitive | Internal stress (MPa) | — | — | — | — | — | — |
| composition | Resolution (μm) | 10 | 10 | 10 | 10 | 10 | 10 |
| | Film remaining percentage (%) | >90 | >90 | >90 | >90 | >90 | >90 |
| | Electrical insulating properties (Ω) | >10¹⁰ | >10¹⁰ | >10¹⁰ | >10¹⁰ | >10¹⁰ | >10¹⁰ |

### REFERENCE SIGNS LIST

1 . . . substrate
2 . . . patterned copper foil
3 . . . base material for electrical insulating properties evaluation

1. A resin composition comprising:
(A) a polymer that comprises a structural unit represented by the formula (a1) and a structural unit represented by the formula (a2); and
(F) a solvent, 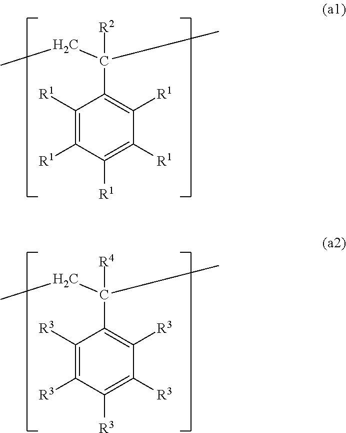
wherein in the formula (a1), a plurality of R¹ are each independently a hydrogen atom or hydroxyl group, provided that at least one R¹ is hydroxyl group; and R² is a hydrogen atom or an alkyl group having 1 to 4 carbon atoms; and
in the formula (a2), a plurality of R³ are each independently a group having a cationic polymerizable group, or a hydrogen atom, provided that at least one R³ is a group having a cationic polymerizable group; and R⁴ is a hydrogen atom or an alkyl group having 1 to 4 carbon atoms.

2. The resin composition according to claim 1, wherein the proportion of the content of the structural unit represented by the formula (a2) in the polymer (A) is 1 to 50 mol % based on 100 mol % of all the structural units of the polymer (A).

3. The resin composition according to claim 1, wherein the proportion of the total content of the structural unit represented by the formula (a1) and the structural unit represented by the formula (a2) in the polymer (A) is 50 to 100 mol % based on 100 mol % of all the structural units of the polymer (A).

4. The resin composition according to claim 1, wherein the cationic polymerizable group in the polymer (A) is an epoxy group.

5. The resin composition according to claim 1, which further comprises (B) a photosensitive compound.

6. The resin composition according to claim 5, which comprises at least a compound having a quinone diazide group or a photosensitive acid-generating agent, as the photosensitive compound (B).

7. The resin composition according to claim 1, which further comprises (C) a crosslinking agent.

8. The resin composition according to claim 7, which comprises at least an oxirane ring-containing compound and an oxetane ring-containing compound that exclude the polymer (A), as the crosslinking agent (C).

9. A polymer comprising a structural unit represented by the formula (a1) and a structural unit represented by the formula (a2): 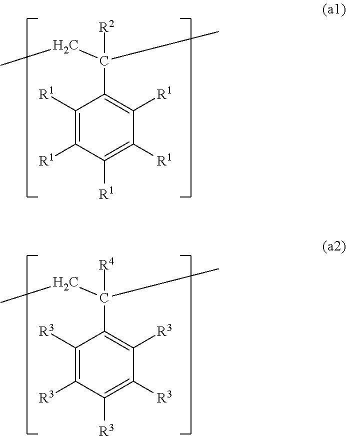
wherein in the formula (a1), a plurality of R¹ are each independently a hydrogen atom or hydroxyl group, provided that at least one R¹ is hydroxyl group; and R² is a hydrogen atom or an alkyl group having 1 to 4 carbon atoms; and
in the formula (a2), a plurality of R³ are each independently a group having a cationic polymerizable group, or a hydrogen atom, provided that at least one R³ is a group having a cationic polymerizable group; and R⁴ is a hydrogen atom or an alkyl group having 1 to 4 carbon atoms.

10. The polymer according to claim 9, wherein the cationic polymerizable group is an epoxy group.

11. A cured film, which is obtained from the resin composition according to claim 5.

12. An electronic part comprising the cured film according to claim 11.

13. The resin composition according to claim 2, wherein the proportion of the total content of the structural unit represented by the formula (a1) and the structural unit represented by the formula (a2) in the polymer (A) is 50 to 100 mol % based on 100 mol % of all the structural units of the polymer (A).

14. The resin composition according to claim 2, wherein the cationic polymerizable group in the polymer (A) is an epoxy group.

15. The resin composition according to claim 3, wherein the cationic polymerizable group in the polymer (A) is an epoxy group.

16. The resin composition according to claim 2, which further comprises (B) a photosensitive compound.

17. The resin composition according to claim 3, which further comprises (B) a photosensitive compound.

18. The resin composition according to claim 4, which further comprises (B) a photosensitive compound.

19. The resin composition according to claim 2, which further comprises (C) a crosslinking agent.

20. The resin composition according to claim 3, which further comprises (C) a crosslinking agent.
